(19) United States
(12) Patent Application Publication
(10) Pub. No.: US 2021/0018402 A1
(43) Pub. Date: Jan. 21, 2021

(54) RIM SIZE MANAGEMENT METHOD FOR TIRE TESTING MACHINE

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 17/040,723

(22) PCT Filed: Mar. 8, 2019
(86) PCT No.: PCT/JP2019/009263

§ 371 Date: Sep. 23, 2020

(30) Foreign Application Priority Data
Mar. 29, 2018 (JP) 2018-064490
Mar. 1, 2019 (JP) 2019-037736

(51) Int. Cl. G01M 17/02; B29D 30/00

(52) U.S. Cl. CPC G01M 17/021; B29D 2030/0066; B29D 30/0061

(57) ABSTRACT

A rim size management method for a tire testing machine includes: a registration step of registering a rim size of each of rims mounted on a rim table in association with a corresponding one of mounting positions on the rim table; a measurement step of actually measuring, with use of a rim measurement mechanism, a size at an outer circumferential edge of at least a first rim mounted at a first mounting position among the plurality of mounting positions; a determination step of determining whether or not the size thus measured at the outer circumferential edge of the first rim corresponds to a registered rim size as the rim size thus registered; and an avoidance step of executing avoidance operation of avoiding contact between the rim and the pair of conveyors when the size at the outer circumferential edge is determined as not corresponding to the registered rim size.

### TECHNICAL FIELD

The present invention relates to a method of managing a rim size for a tire testing machine that is a size of a rim mounted on a rim table included in the tire testing machine.

### BACKGROUND ART

There has conventionally been known a tire testing machine configured to test a plurality of tires having varied inner circumferential diameters or varied tread surface widths (e.g. Patent Literature 1). Such a tire testing machine includes a plurality of rims adapted to a plurality of tire sizes. The tire testing machine includes a rim table provided thereon with the plurality of rims, and a spindle unit to which a rim is attached. The tire testing machine includes a mechanism configured to replace the rim attached to the spindle unit with one of the rims mounted on the rim table, and achieves automatic or semiautomatic replacement of the rim with use of the mechanism.

The rim table typically has a plurality of mounting positions (a plurality of positions) for the plurality of rims. Each of the rims stocked (mounted) on the rim table is managed in association with a corresponding one of the mounting positions. Information on the sizes of the plurality of rims is preliminarily registered in a control unit configured to control operation of the tire testing machine, or the like.

Upon rim replacement of attaching, to the spindle unit, one (attachment target rim) of the rims mounted on the rim table in the tire testing machine, in a state where a pair of conveyor units provided to convey a tire and configured to be close to and separate from each other has a gap therebetween adjusted to an appropriate gap adapted to a rim size of the attachment target rim, the attachment target rim passes between the pair of conveyor units to shift from the rim table to above the pair of conveyor units. In a case where the tire testing machine has a rim automatically replacing function, upon the rim replacement, the control unit in the tire testing machine selects a rim adapted to a size of a tire to be subsequently tested in accordance with the registered information on the sizes of the rims, and automatically adjusts the gap between the pair of conveyor units to the appropriate gap such that the selected rim can pass between the pair of conveyor units.

Smooth execution of automatic rim replacement in the tire testing machine thus configured needs correctness of the preliminarily registered information on the sizes of the rims. The preliminarily registered information on the sizes of the rims is manually inputted by an operator after the plurality of rims is mounted on the rim table.

For some reason, there may be, however, inconvenience that one of the rim sizes thus registered is different from the size of a corresponding one of the rims mounted on the rim table. In such a case, the control unit stores a size different from the size of the rim actually mounted on the rim table.

Storage of such incorrect information on the size of any one of the rims may lead to the following defect upon the rim replacement.

As exemplarily depicted in FIG. 8, upon rim replacement of replacing a rim attached to a spindle unit with a rim 104 stocked on a rim table in a tire testing machine 100, a pair of conveyor units 101 (a pair of conveyor units adopting a roller conveyor system in exemplary depiction) may be adjusted to have a gap not adapted to an actual rim size in accordance with incorrect registered information and the rim 104 may thus come into contact with any of the conveyor units 101.

In a case where the gap between the pair of conveyor units 101 is not adjusted to be wider than an outer circumferential diameter of the rim 104 to be attached to the spindle unit, or is incorrectly adjusted to be narrower than a required gap, the rim 104 passing between the pair of conveyor units 101 may come into contact with any of the conveyor units 101 to damage the conveyor units.

### CITATION LIST

### Patent Literature

Patent Literature 1: JP 2013-104744 A

### SUMMARY OF INVENTION

It is an object of the present invention to provide a rim size management method for a tire testing machine, achieving avoidance of contact between an attachment target rim that is one of rims mounted on a rim table and a conveyor unit upon rim replacement of attaching the attachment target rim to a spindle unit after detaching a rim from the spindle unit.

The present invention provides a rim size management method for a tire testing machine. The tire testing machine includes a pair of conveyors configured to convey a tire as a target of a tire test, a rim table disposed below the pair of conveyors and having a plurality of mounting positions to be provided with the plurality of rims including a first rim and a second rim and varied in rim size, a spindle unit to be provided with a rim, and a rim measurement mechanism. The tire testing machine is configured to shift an attachment target rim mounted at one of the mounting positions from the rim table to above the pair of conveyors by allowing the attachment target rim to pass between the pair of conveyors in a state where the pair of conveyors has an appropriate gap adjusted to be adapted to a rim size of the attachment target rim when the attachment target rim is attached to the spindle unit. The rim size management method according to the present invention relates to a management method of managing a rim size of each of the rims in the tire testing machine. The rim size management method includes: a registration step of registering a rim size of each of the rims mounted on the rim table in association with a corresponding one of the mounting positions; a measurement step of actually measuring, with use of the rim measurement mechanism, a size at an outer circumferential edge of at least the first rim mounted at a first mounting position among the plurality of mounting positions; a determination step of determining whether or not the size thus measured at the outer circumferential edge of the first rim corresponds to a registered rim size as the rim size preliminarily registered in association with the first mounting position; and an avoidance step of executing avoidance operation of avoiding contact between the attachment target rim and the pair of conveyors when the size at the outer circumferential edge of the first rim is determined as not corresponding to the registered rim size.

### BRIEF DESCRIPTION OF DRAWINGS

FIG. 1 is a plan view of a tire testing machine according to an embodiment of the present invention.

FIG. 2 is a front view of the tire testing machine according to the embodiment.

FIG. 3 is a side view, from an inlet, of the tire testing machine according to the embodiment.

FIG. 4 is a schematic plan view of a rim measurement mechanism and a rim substituting mechanism.

FIG. 5 is a schematic plan view of the rim measurement mechanism.

FIG. 6 is a schematic front view of the rim measurement mechanism.

FIG. 7 is a plan view schematically depicting an entire configuration of the tire testing machine.

FIG. 8 is a plan view schematically depicting conveyor units adopting a roller conveyor system.

FIG. 9 includes a plan view and a side view schematically exemplifying another rim measurement mechanism.

### DESCRIPTION OF EMBODIMENTS

A rim size management method for a tire testing machine 1 according to an embodiment of the present invention will now be described hereinafter with reference to the drawings.

The embodiment to be described below specifically exemplifies the present invention that should not be limited to such specific exemplification.

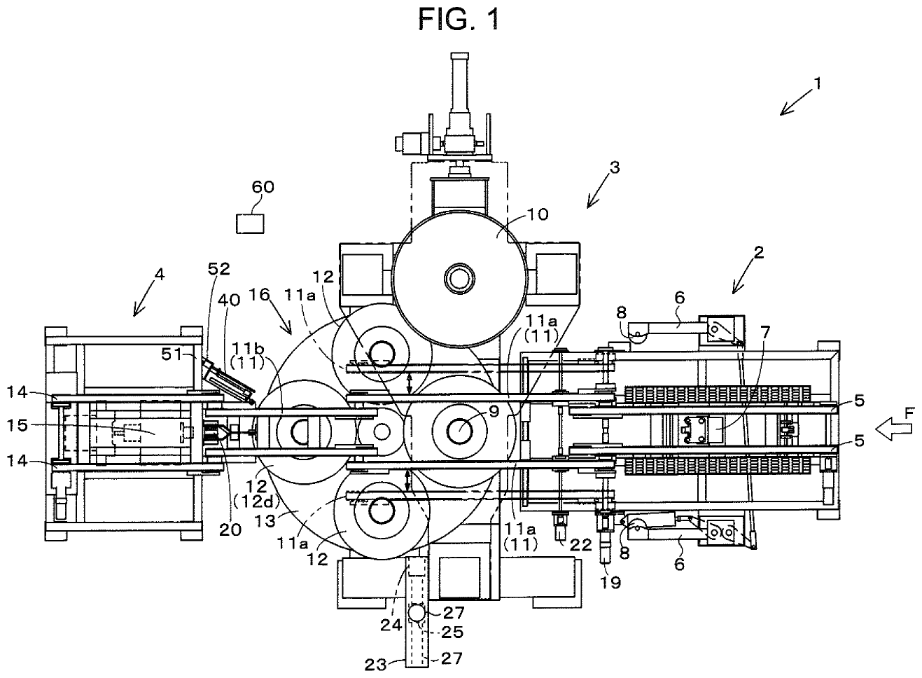

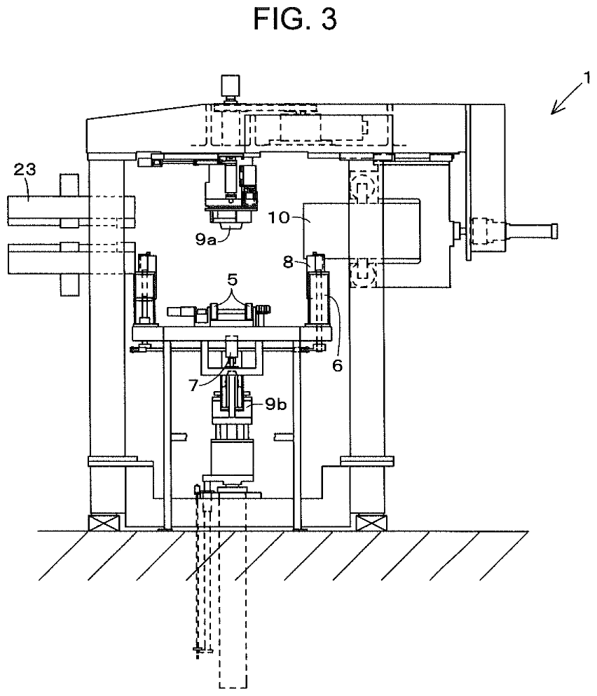

FIG. 1 to FIG. 7 each depict the tire testing machine 1 according to the embodiment.

The tire testing machine 1 to be described hereinafter has an entire length corresponding to a length of a conveyance route F of a tire T in a conveyance direction of the tire T. The tire testing machine 1 has a depth direction corresponding to a horizontal direction crossing the conveyance route F, more precisely, the horizontal direction substantially perpendicular to the conveyance route F. The depth direction will also be called a transverse direction or a width direction of the tire testing machine 1.

The tire testing machine 1 includes a lubrication section 2, a tire testing section 3, and a marking section 4. The lubrication section 2 rotates the tire T and simultaneously applies lubrication liquid to a bead portion B of the tire T. The tire testing section 3 causes the tire T provided with the lubrication liquid by the lubrication section 2 to rotate on a spindle, and simultaneously conducts a tire test to detect any singular point on the tire T. The marking section 4 marks a circumferential position of the singular point on the tire T.

The lubrication section 2, the tire testing section 3, and the marking section 4 are aligned in the mentioned order from an upstream side to a downstream side along the conveyance route F.

The lubrication section 2 includes a pair of left and right first conveyors 5 configured to convey the tire T laid horizontally, a pair of left and right arms 6 configured to hold the tire T delivered by the pair of first conveyors 5, and an applicator 7 configured to apply lubrication liquid to the bead portion B (inner circumferential edge) of the tire T held between the pair of arms 6.

The paired first conveyors 5 according to this embodiment are each constituted as a belt conveyor including a conveyance belt which is a loop-shaped strip forming an endless track.

The paired arms 6 each have a tip provided with a rotatable roller 8. The pair of arms 6 sandwiches the delivered tire T from both left and right outer sides, and causes the rollers 8 to come into contact with a tread surface constituting an outer circumferential surface of the tire T. The rollers 8 rotate to allow the tire T to rotate about a vertical axis. The applicator 7 is configured to be vertically shiftable. The applicator 7 has a brush shape and is configured to ascend to come into contact with the bead portion B of the tire T held between the pair of arms 6 and apply the lubrication liquid to the bead portion B. After the application, the applicator 7 is returned to a position below the first belt conveyors 5 to be accommodated.

The pair of first conveyors 5 conveys the tire T thus provided with the lubrication liquid from the lubrication section 2 to the tire testing section 3 as a main section.

The tire testing section 3 includes a spindle unit 9, a drum 10, a pair of left and right second conveyor units 11, a rim table 13, and a rim substituting mechanism 16.

The spindle unit 9 holds the tire T rotatably about the vertical axis. The drum 10 has a cylindrical outer circumferential surface having a vertically directed center axis, and is disposed laterally to the spindle unit 9 so as to be rotatable about the center axis.

The pair of second conveyor units 11 conveys the tire T delivered from the lubrication section 2 while the tire T is kept laid horizontally. The rim table 13 has a horizontal rim mounting surface allowing a plurality of rims 12 to be mounted thereon. The rim table 13 has a plurality of mounting positions to be provided with the plurality of rims 12 varied in rim size.

The rim substituting mechanism 16 operates to allow a substitution target rim 12d selected from the rims 12 mounted on the rim mounting surface to be substituted by a substitute rim (a rim prepared outside the tire testing machine).

The paired second conveyor units 11 according to this embodiment are each constituted by an upstream conveyor 11a and a downstream conveyor 11b disposed downstream of the upstream conveyor 11a in the conveyance direction. The upstream and downstream conveyors 11a and 11b are each constituted as a belt conveyor including a conveyance belt which is a loop-shaped strip forming an endless track. In other words, the pair of second conveyor units 11 includes a pair of left and right upstream conveyors 11a mentioned above and a pair of left and right downstream conveyors 11b mentioned above, which are disposed on left and right sides of the axis of the spindle unit 9. The pair of upstream conveyors 11a exemplifies a pair of conveyors relevant to the rim size management method according to the present invention.

The tire testing section 3 further includes a rotary drive section (not depicted) configured to rotationally drive the spindle unit 9.

The tire testing machine 1 further includes a grinder 23. When the tire T has a value exceeding an allowable value for a tire test, the grinder 23 grinds a shoulder at a boundary between the tread surface and a side wall of the tire T. The grinder 23 is disposed adjacent to an outlet of the tire testing section 3. The tire T is thus adjusted to have a value within the allowable value of a measured item for the tire test.

The tire T is supported by the spindle unit 9 via the rim 12 to be rotatable about the vertical axis. The rim 12 is has a structure divided into two parts, namely, an upper rim 12a and a lower rim 12b, to hold the tire T by sandwiching from upper and lower sides.

The spindle unit 9 includes an upper spindle 9a and a lower spindle 9b. The upper spindle 9a and the lower spindle 9b are bar members rotatable about a common vertical axis.

The rims 12 are each constituted by an upper rim 12a attached to a lower end of the upper spindle 9a, and a lower rim 12b attached to an upper end of the lower spindle 9b. The upper rim 12a and the lower rim 12b are disposed to vertically sandwich the tire T placed on the pair of second belt conveyor units 11.

The rim table 13 is disposed adjacent to the lower spindle 9b. The upper rim 12a and the lower rim 12b are vertically stacked and are mounted on the rim mounting surface.

The drum 10 is disposed such that the outer circumferential surface of the drum 10 can be radially close to and separate from the tread surface of the tire T held by the spindle unit 9. The tire T is tested while rotating at predetermined rotational speed in a state where the outer circumferential surface of the drum is in contact with the tread surface of the tire T. The drum 10 has a rotary shaft provided with a load cell (not depicted) configured to measure force, a moment, or the like applied from the rotating tire T to the drum 10.

Tire uniformity or the like is calculated from a result of measurement by the load cell. Measured as a “singular point” is a circumferential position, an axial position, or the like where the tire T has the largest repulsive force. The tire testing section 3 conducts the tire test including measurement of the tire uniformity as well as measurement of an outer shape and the like.

The tire T having the “singular point” thus measured is rotated by the tire testing section 3 by a predetermined angle, and is then sent from the tire testing section 3 to the marking section 4.

The marking section 4 includes a pair of left and right third conveyors 14, and an mark stamping device 15. The pair of third conveyors 14 shifts, in the conveyance direction, the tire T kept laid horizontally. The mark stamping device 15 marks a predetermined position on the inner circumference of the tire T positioned on the pair of third conveyors 14. The paired third conveyors 14 according to this embodiment are each constituted as a belt conveyor including a conveyance belt which is a loop-shaped strip forming an endless track.

In a case where the tire testing section 3 conducts the tire test relevant to tire uniformity of the tire T, the mark stamping device 15 provides the circumferential position on the tire T having a “singular point” in terms of the tire uniformity with a mark like a uniformity mark indicating the singular point specified in the tire test. In another case where the tire test being conducted is relevant to measurement of the outer shape or the like, the tire T may be provided with a mark other than the uniformity mark.

The tire testing section 3 further includes a slide mechanism 22. The slide mechanism 22 is constituted as a gap change mechanism configured to change a transverse gap between the pair of upstream conveyors 11a in the pair of second conveyor units 11 by shifting the pair of upstream conveyors 11a to be transversely close to and separate from each other. The slide mechanism 22 is configured to slide the pair of upstream conveyors 11a in this direction (transverse direction). The slide mechanism 22 may include a ball screw extending transversely and having a left female screw part and a right male screw part opposed to each other, and a motor configured to rotate the ball screw. The left female screw part and the right male screw part are screwed respectively to nuts fixed to the pair of upstream conveyors 11a. The motor rotates the ball screw normally or reversely to slide the pair of upstream conveyors 11a to be close to and separate from each other. The pair of upstream conveyors 11a slides to be close to and separate from each other so as to allow, upon change in size of the tire T to be tested, the rim 12 adapted to the changed size to be extracted from the rim table 13 positioned below the pair of upstream conveyors 11a in the second conveyor units 11.

Specifically, in order to change to a larger rim, the pair of upstream conveyors 11a is slid to be separated from each other, in other words, transversely outward. The rim 12 adapted to the changed size can thus leave the rim table 13 and pass through a space between the pair of upstream conveyors 11a. The tire T held at the rim 12 and having been measured is received by and left on the pair of upstream conveyors 11a when the rim 12 descends, and is then sent to the pair of downstream conveyors 11b. The tire testing machine 1 is configured to change the gap between the pair of upstream conveyors 11a in accordance with an outer circumferential diameter of the rim.

The rim table 13 according to the present embodiment is a disc plate member positioned to be overlapped with the lower spindle 9b in a planar view. The tire testing section 3 further includes a rotary drive mechanism 18 that supports the rim table 13 rotatably about a vertical axis and is configured to rotate the rim table 13. In other words, the rim table 13 according to the present embodiment is constituted as a rotary table.

The rim mounting surface of the rim table 13 can be provided thereon with the plurality of rims 12 varied in size, at the plurality of mounting positions aligned in a rotary circumferential direction of the rim table 13. The rim table 13 has through holes that are provided at sites respectively corresponding to the plurality of mounting positions and each have a size set to allow the lower spindle 9b vertically shifting to enter and leave. The upper rim 12a and the lower rim 12b constituting each of the rims 12 are vertically stacked and mounted on the rim mounting surface, and can be attached to the upper spindle 9a and the lower spindle 9b, respectively.

The rim table 13 according to the present embodiment can be provided with the plurality of rims 12 different in size, at four mounting positions aligned in the rotary circumferential direction on the rim mounting surface. The rim table 13 has a rotary center axis positioned closer to an export port (outlet) than the spindle unit 9 in the conveyance direction.

The tire testing section 3 has a rim automatically replacing function. the rim automatically replacing function enables, even if the tire testing section 3 receives tires T varied in size to have inner circumferential diameters or tread surface widths different from each other, continuous tire tests of the tires T.

Specifically, the rim automatically replacing function achieves automatic change, according to information on a size or the like of a subsequent tire T delivered from the upstream lubrication section 2, from the rim 12 attached to the spindle unit 9 to the rim 12 adapted to the size or the like of the tire T, for conduct of the tire tests on the tires T varied in size.

Upon change of the tire T as a target of the tire test, initially executed is a step of separating, from the spindle unit 9, the rim 12 currently mounted to the spindle unit 9. Specifically, in a state where the subsequent tire T stands by in front of the tire testing section 3, the tire T having been subjected to the tire test is detached from the spindle unit 9 and is conveyed to the marking section 4. The pair of second conveyor units 11 stops being driven after the conveyance.

The rim 12 is separated from the spindle unit 9 by raising the lower spindle 9b and integrating the lower rim 12b attached to the lower spindle 9b and the upper rim 12a, detaching the upper rim 12a from the upper spindle 9a, and lowering the entire rim 12 including the lower rim 12b and the upper rim 12a integrated together to the rim table 13. Even after the rim 12 is mounted on the rim table 13, the lower spindle 9b further descends to detach the rim 12 from the lower spindle 9b and reach a position below the rim table 13.

Subsequently executed is a step of mounting, to the spindle unit 9, the rim 12 adapted to the subsequent tire T thus changed. In a case where the subsequent tire T is larger in inner circumferential diameter than the previous tire T, the pair of upstream conveyors 11a in the pair of second conveyor units 11 is slid transversely outward to have a larger gap adjusted in accordance with information on the tire T.

Furthermore, the rim 12 having an outer circumferential diameter adapted to the inner circumferential diameter of the subsequent tire T is selected, in accordance with the information on the tire T, from among the plurality of rims 12 stocked on the rim table 13 disposed below the second conveyor units 11 and adapted to the tires T varied in size. The rim 12 thus selected can be transferred to a position right above the lower spindle 9b standing by, by rotation of the rim table 13 driven by the rotary drive mechanism 18.

The lower spindle 9b standing by ascends to mount the selected rim 12 to the lower spindle 9b. The lower spindle 9b further ascends to attach the upper rim 12a in the rim 12 to the upper spindle 9a. The lower spindle 9b then descends while holding the lower rim 12b, to vertically separate the upper rim 12a and the lower rim 12b. When the lower rim 12b descends to reach a standby position below the pair of second conveyor units 11, the subsequent tire T is delivered to be positioned for the tire test. The rim 12 is replaced automatically in this manner.

As described above, the pair of second conveyor units 11 according to this embodiment includes the pair of upstream conveyors 11a positioned adjacent to an inlet of the conveyance route F, and the downstream conveyors 11b positioned adjacent to an outlet. The pair of upstream conveyors 11a is longer than the pair of downstream conveyors 11b in the conveyance direction. The upper spindle 9a and the lower spindle 9b are disposed above and below the upstream conveyors 11a, respectively. Accordingly, the tire testis conducted for the tire T conveyed to the tire testing section 3, while being disposed on the upstream conveyors 11a.

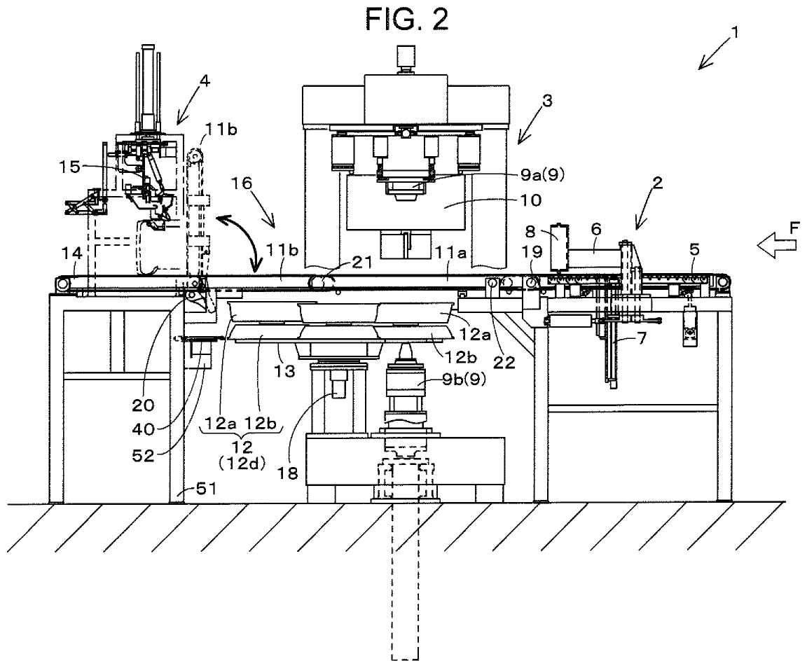

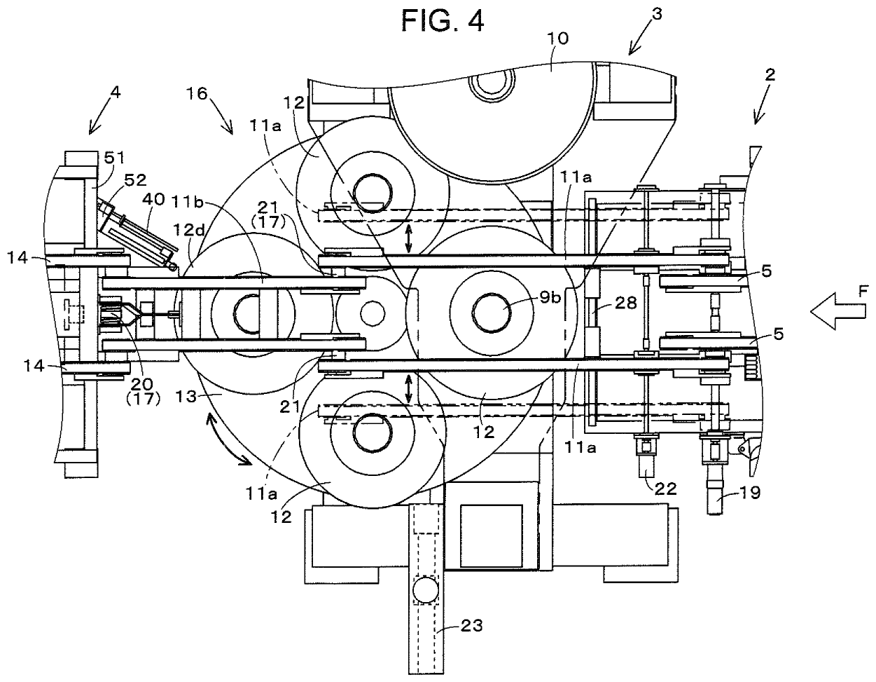

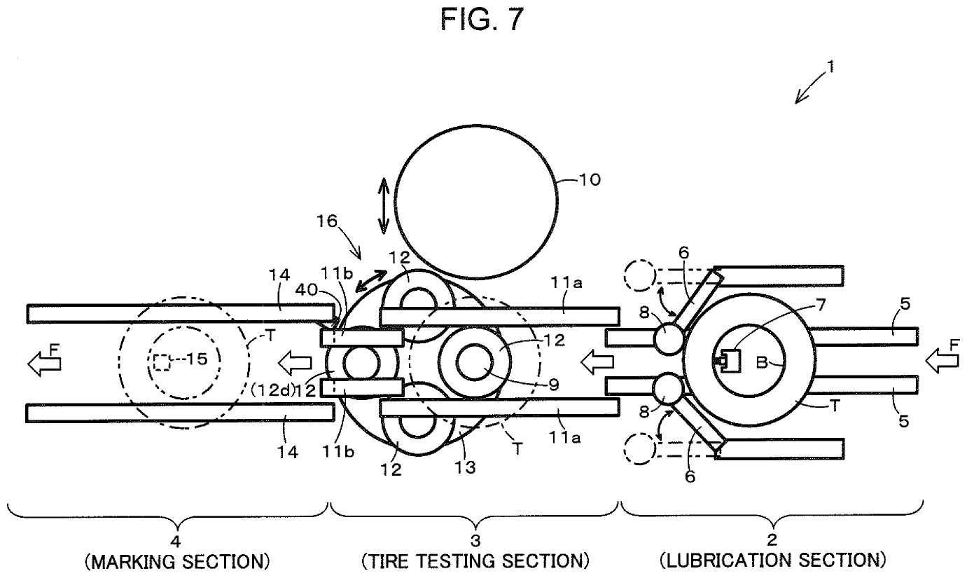

The pair of downstream conveyors 11b shorter in length than the pair of upstream conveyors 11a is disposed transversely inside the pair of upstream conveyors 11a to be transversely interposed between the pair of upstream conveyors 11a. Specifically, the downstream conveyors 11b have upstream ends (right ends in FIG. 1, FIG. 2, FIG. 4, and FIG. 7) overlapped in the conveyance direction with downstream ends (left ends in FIG. 1, FIG. 2, FIG. 4, and FIG. 7) of the upstream conveyors 11a, and the upstream ends and the downstream ends are coupled to each other during a regular period for conduct of the tire test.

The tire testing machine 1 according to this embodiment further includes a raising and lowering mechanism 17. The raising and lowering mechanism 17, the rotary drive mechanism 18, and the slide mechanism 22 constitute the rim substituting mechanism 16 configured to substitute the substitution target rim 12d selected from the plurality of rims 12 mounted on the rim mounting surface by a different rim.

As depicted in FIG. 1 to FIG. 4, the raising and lowering mechanism 17 supports, while the tire test is stopped, the pair of downstream conveyors 11b rotatably in a rising direction of raising about the downstream ends of the pair of downstream conveyors 11b as fulcrums and in a lowering direction reverse to the rising direction. Upon the pair of downstream conveyors 11b rising in the rising direction, the upstream ends of the pair of downstream conveyors 11b shift upward to be separated from the downstream ends of the pair of upstream conveyors 11a. The raising and lowering mechanism 17 according to this embodiment has a function of moving the pair of downstream conveyors 11b in the rising direction and the lowering direction. The rotary drive mechanism 18 rotates the rim table 13 about the vertical axis as described above, to shift the substitution target rim 12d among the plurality of rims 12 to a substitution position. At the substitution position, the substitution target rim 12d is substituted by the different rim while vertically passing through the pair of second conveyor units 11. As described earlier, while the tire test is stopped, the slide mechanism 22 shifts the pair of upstream conveyors 11a to be close to and separate from each other in the direction crossing the conveyance direction of the conveyance route F, specifically, in the transverse direction, to change the transverse gap between the pair of upstream conveyors 11a.

The substitution position according to the present embodiment is opened upward through a space formed by raising the downstream conveyors 11b as indicated by two-dot chain lines in FIG. 2, in other words, the space occupied by the downstream conveyors 11b before being raised. The substitution position for the rim 12 is set right below the space formed adjacent to an export port of the tire testing section 3 by raising the downstream conveyors 11b.

The raising and lowering mechanism 17 is preferred to further include a raising and lowering drive motor 20 configured to automatically raise or lower the downstream conveyors 11b while the tire test is stopped, and a coupling member 21. The raising and lowering drive motor 20 is coupled to rotary basal ends of the downstream conveyors 11b (the downstream ends adjacent to the marking section 4 in this embodiment), and operates to rotate the downstream conveyors 11b in the rising and lowering direction about the fulcrums at the downstream ends, in other words, to raise or lower the upstream ends of the downstream conveyors 11b. The coupling member 21 is switched between a state of coupling the upstream ends of the downstream conveyors 11b and the downstream ends of the upstream conveyors 11a and a state of decoupling.

The raising and lowering mechanism 17 is not limitedly configured to automatically raise or lower the downstream conveyors 11b with use of the raising and lowering drive motor 20 or the like. The raising and lowering mechanism 17 has only to be configured to switch the downstream conveyors 11b into a lowered posture (i.e. a posture of positioning the upstream ends of the downstream conveyors 11b to be flush with the downstream ends of the upstream conveyors 11a to enable conveyance of the tire T) and a raised posture (i.e. a posture of raising the upstream ends of the downstream conveyors 11b to be higher than the downstream ends of the upstream conveyors 11a to form a space allowing the substitution target rim 12d to vertically pass therethrough). In other words, the raising and lowering mechanism 17 has only to be configured to support the downstream conveyors 11b to be raised or lowered between a position corresponding to the lowered posture and a position corresponding to the raised posture. Accordingly, the raising and lowering mechanism may not necessarily include the raising and lowering drive motor 20 or an equivalent drive unit. For example, the raising and lowering mechanism may allow an operator to cancel coupling by the coupling member 21 between the upstream ends of the downstream conveyors 11b and the downstream ends of the upstream conveyors 11a and manually move the downstream conveyors 11b from the lowered posture to the raised posture.

When the tire test is stopped for substitution of the rim 12, the rim 12 having been mounted to the spindle unit 9 is detached from the spindle unit 9 that descends to reach the standby position below the rim table 13. The rim 12 detached from the spindle unit 9 is selected as the subsequent substitution target rim 12d, and the rotary drive mechanism 18 drives to rotate the rim table 13 to transfer the substitution target rim 12d to the substitution position in accordance with information on the mounting position of the substitution target rim 12d.

For rim automatic replacement, the rotary drive mechanism 18 also drives to rotate the rim table 13 to shift the rim 12 adapted to the delivered tire T to the position right above the lower spindle 9b in accordance with the information on the tire T.

The slide mechanism 22 also drives to slide the pair of upstream conveyors 11a for rim automatic replacement. Specifically, the slide mechanism 22 can further increase the transverse gap between the pair of upstream conveyors 11a from the gap to be increased for rim automatic replacement upon substitution of the rim 12, as indicated by two-dot chain lines in FIG. 4.

The tire testing machine 1 according to the present embodiment further includes a support drive mechanism 19 and a guide 28, which cantilever support the pair of upstream conveyors 11a to avoid interference between the pair of upstream conveyors 11a and the rim 12 to be replaced. Specifically, the support drive mechanism 19 is positioned closer to an import port (upstream of) the tire testing section 3, and supports each of the paired upstream conveyors 11a at one point upon substitution of the rim 12.

Each of the paired upstream conveyors 11a includes a driving roller positioned at the upstream end of the upstream conveyor 11a and rotationally driven by the support drive mechanism 19, a driven roller positioned at the downstream end of the upstream conveyor 11a, and the conveyance belt that spans between the driving roller and the driven roller. The support drive mechanism 19 includes a ball spline extending transversely, and a belt drive motor configured to drive to rotate the ball spline. The ball spline is coupled to the driving roller to allow transverse slide of the driving roller as well as transmission of rotary drive force of the belt drive motor to the driving roller. The belt drive motor rotates the driving roller via the ball spline to drive the conveyance belt in the conveyance direction. The guide 28 is constituted as a linear guide supporting the pair of upstream conveyors 11a slidably in the transverse direction.

The support drive mechanism 19, the guide 28, and the slide mechanism 22 each support the pair of upstream conveyors 11a at a position upstream in the conveyance direction (adjacent to the inlet) of an upstream end of the rim table 13, so as not to interfere with the rim 12 upon substitution of the rim 12 mounted on the rim table 13. The slide mechanism 22 further increases the gap between the pair of upstream conveyors 11a to prevent interference between the pair of upstream conveyors 11a and the rim 12.

Described next is operation of the rim substituting mechanism 16. When the tire test is stopped, the rim 12 mounted to the spindle unit 9 is detached from the spindle unit 9, and the lower spindle 9b in the spindle unit 9 stands by at a position below the rim table 13. Safety recognition is followed by cancellation of coupling, by the coupling member 21 of the raising and lowering mechanism 17, between the downstream ends of the pair of upstream conveyors 11a and the upstream ends of the pair of downstream conveyors 11b, so that the pair of upstream conveyors 11a and the pair of downstream conveyors 11b are separated from each other. The raising and lowering drive motor 20 operates in this state to raise the pair of downstream conveyors 11b in the lowered posture to a raised position indicated by the two-dot chain lines in FIG. 2. Specifically, the upstream ends of the pair of downstream conveyors 11b are rotated upward about the basal ends, or the downstream ends of the pair of downstream conveyors 11b.

Meanwhile, the slide mechanism 22 slides the pair of upstream conveyors 11a transversely outward to increase the gap between the pair of upstream conveyors 11a maximumly within an allowable range (to the maximum gap) as indicated by the two-dot chain lines in FIG. 4.

There is thus secured a sufficient space for substitution, above the substitution position for substitution of the substitution target rim 12d. The rotary drive mechanism 18 subsequently rotates the rim table 13 about the vertical axis to shift the substitution target rim 12d to the substitution position in accordance with the information on the mounting position of the substitution target rim 12d.

The substitution target rim 12d thus shifted to the substitution position can be detached from the rim table 13 to vertically pass between the pair of second conveyor units 11 with use of the space secured above the substitution position. Furthermore, a rim externally prepared and different in size from the substitution target rim 12d is mounted, through the space, at the site having been provided with the substitution target rim 12d on the rim table 13.

After the rim different in size is mounted, the raising and lowering drive motor 20 in the rim substituting mechanism 16 operates to move the pair of downstream conveyors 11b from the raised posture to the lowered posture again. The slide mechanism 22 subsequently operates to shift the pair of upstream conveyors 11a transversely inward. After the pair of upstream conveyors 11a completes shifting, the coupling member 21 is returned into the state of coupling the pair of upstream conveyors 11a and the pair of downstream conveyors 11b. After the rim substituting mechanism 16 completes substitution of the rim 12, a subsequent tire test is conducted.

Described next is the rim size management method for the tire testing machine 1 according to the present embodiment. The rim size management method includes managing rim sizes of the plurality of rims 12 mounted on the rim table 13.

As described earlier, the rim sizes of the rims 12 are managed to prevent contact between the rim 12 supported by the lower spindle 9b and ascending along with ascension of the lower spindle 9b and the pair of upstream conveyors 11a positioned above the rim table 13, upon rim replacement of replacing the rim 12 attached to the spindle unit 9 with one of the rims 12 mounted on the rim table 13.

The rim size management method according to the present embodiment also has an object to prevent inconvenient failure in normal conduct of the tire test due to the rim size of the rim 12 not adapted to the tire size.

In a case where the rim size of the rim 12 is smaller than the tire size, the rim 12 does not contact the pair of second conveyor units 11 upon rim replacement, but there is provided a gap between an inner circumference of the tire T and an outer circumference of the rim 12. In such a case, air is less likely to enter the tire T that may contain air not reaching test pressure. Internal pressure of the tire T is monitored by a pressure sensor, and the tire testing machine 1 has an error if the internal pressure does not reach the test pressure. In view of this, the tire testing machine 1 according to the present embodiment is thus configured to monitor whether or not the rim 12 selected for rim replacement is adapted to the tire T to be tested. The rim 12 is managed in terms of the rim size in this manner to advantageously detect abnormality of maladaptation between the rim 12 and the tire T before conduct of the tire test.

The rim size management method according to the present embodiment includes actually measuring the rim size of at least one measurement target rim among the plurality of rims 12 mounted on the rim table 13, collating information on the rim 12 obtained by the actual measurement with preliminarily registered information on the rims, and determining whether or not these two pieces of information match, for management of the rim size.

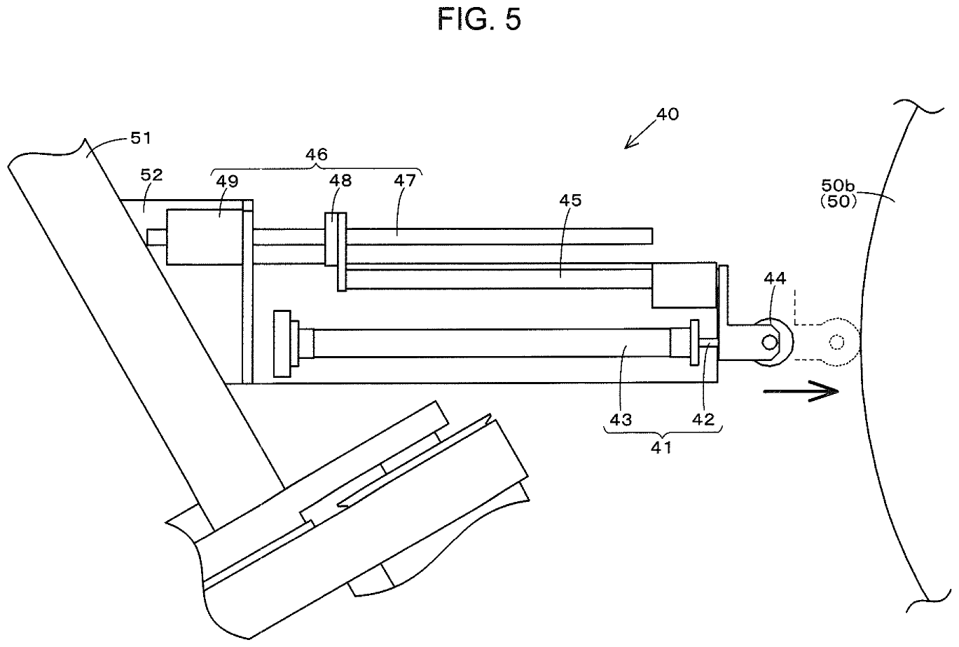

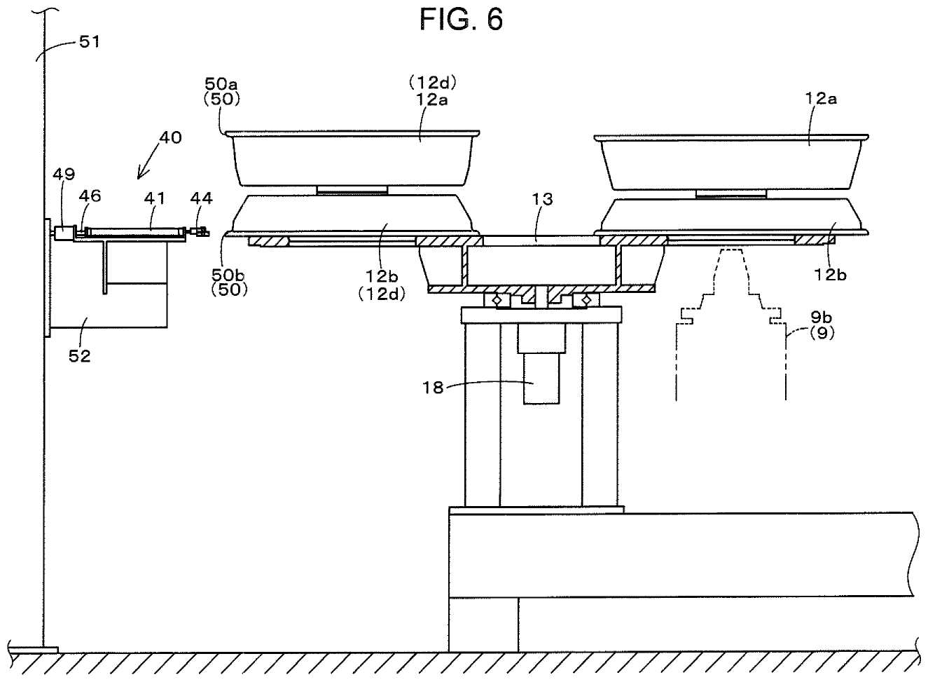

As depicted in FIG. 5 and FIG. 6, the tire testing machine 1 further includes a rim measurement mechanism 40. The rim measurement mechanism 40 is provided in a region downstream of the tire testing section 3, or adjacent to the outlet of the tire testing section 3. The rim measurement mechanism 40 measures the rim size of the measurement target rim 12 among the plurality of rims 12 mounted on the rim table 13.

As depicted in FIG. 5, the rim measurement mechanism 40 is configured to measure a size at an outer circumferential edge 50 of the rim 12. The rim measurement mechanism 40 includes an expansion mechanism 41 configured to expand and contract, a measurement section 46, and a guide member 45. The expansion mechanism 41 has a tip provided with a probe 44. In other words, the tip of the expansion mechanism 41 is constituted by the probe 44. The expansion mechanism 41 is disposed to have an expansion direction directed to the outer circumferential edge 50 (flange) of the rim 12. The measurement section 46 is disposed to have a posture having an extension direction of a bar member 47 to be described later being in parallel with the expansion direction of the expansion mechanism 41. The guide member 45 is disposed to have a posture being in parallel with the bar member 47 of the measurement section 46, that is, being in parallel with the expansion direction of the expansion mechanism 41. The guide member 45 links the expansion mechanism 41 and the measurement section 46. The rim measurement mechanism 40 is controlled by a controller 60 (control section) configured to control operation of the tire testing machine 1. The controller 60 (see FIG. 1) is constituted by a computer or the like.

According to the present embodiment, the expansion mechanism 41 is constituted by an air cylinder 41, the probe 44 includes a rotatable roller, and the measurement section 46 is constituted by a displacement sensor 46.

The rim measurement mechanism 40 measures the size at the outer circumferential edge 50 (flange 50) of at least one of the upper rim 12a and the lower rim 12b constituting the rim 12. The rim measurement mechanism 40 according to the present embodiment measures the size at the outer circumferential edge 50 of the lower rim 12b, specifically, a diameter at a lower flange 50b of the lower rim 12b. The lower flange 50b is a portion having the largest diameter in the lower rim 12b. For example, the size at the outer circumferential edge 50 measured by the rim measurement mechanism 40 may be a radius at the lower flange 50b of the lower rim 12b.

The upper rim 12a and the lower rim 12b are provided as separate components. The upper rim 12a may accordingly be combined with the lower rim 12b different in size from the upper rim 12a for some reason. In a case where the operator is not aware of such combination of the upper and lower rims different in size, the following problem may occur. In a case where the upper rim 12a is larger in size than the lower rim 12b to be measured by the rim measurement mechanism 40, the upper rim 12a may come into contact with the pair of second conveyor units 11. Only the lower rim 12b is measured as in the present embodiment for the following reason.

The upper rim 12a and the lower rim 12b are appropriately paired to be stored, and are thus actually less likely to have combination of different sizes. A rim size is a size of a rim, the rim size indicating one selected from a plurality of predetermined and stepwisely differentiated sizes (e.g. sizes denoted by signs R15, R16, and the like). When the upper rim 12a and the lower rim 12b are different in size, the operator can thus visually recognize the difference. If the rim measurement mechanism 40 measures the sizes of both the upper rim 12a and the lower rim 12b, the tire testing machine 1 is complicated in terms of its configuration. In consideration of both manufacturing cost for the tire testing machine 1 and possibility of incorrect combination, the rim measurement mechanism 40 according to the present embodiment has, as the measurement target, only the diameter at the outer circumferential edge 50 of the lower rim 12b. The diameter at the outer circumferential edge 50 of the rim 12 may be measured with use of a bar member standing vertically, in place of the probe 44. Even if the upper rim 12a and the lower rim 12b are different in size, measurement with use of the bar member enables detection of the rim size of a larger one of the upper rim 12a and the lower rim 12b.

The rim measurement mechanism 40 according to the present embodiment is provided at a support member 52 attached to a frame member 51 constituting the marking section 4. The rim measurement mechanism 40 is provided to project from an upstream portion (adjacent to an inlet) of the marking section 4 toward a downstream portion (adjacent to the outlet) of the tire testing section 3. The rim measurement mechanism 40 is supported by the support member 52 to project toward the outer circumferential edge 50 (lower flange 50b) of the lower rim 12b.

The air cylinder 41 constituting the expansion mechanism 41 includes a cylinder rod 42 having a bar shape, and a case body 43 having a long cylindrical shape. The cylinder rod 42 is configured to be shiftable relatively to the case body 43 in a longitudinal direction of the cylinder rod 42. The cylinder rod 42 is configured to be shiftable relatively to the case body 43 in a direction toward the lower flange 50b of the lower rim 12b and its reverse direction. The cylinder rod 42 shifts in the reverse direction to be accommodated in the case body 43.

The cylinder rod 42 has a tip provided with the probe 44. The tip of the cylinder rod 42 is fixed to a front end of the guide member 45. The guide member 45 is constituted as a long bar member. The guide member 45 has an axis directed identically to an axis of the air cylinder 41. The guide member 45 is disposed between the air cylinder 41 and the displacement sensor 46.

The displacement sensor 46 includes the bar member 47 having a long bar shape, a traveling member 48 shiftable along an outer peripheral surface of the bar member 47 in a longitudinal direction of the bar member 47, a detector 49 configured to detect a travel amount (travel distance) of the traveling member 48, and a rim diameter measurement part configured to calculate the diameter at the outer circumferential edge 50 (lower flange 50b) of the rim 12 in accordance with the travel distance thus detected, to obtain the size of the rim 12.

Specific examples of the displacement sensor 46 include a magnetostriction displacement sensor. The displacement sensor according to the present embodiment is constituted as the magnetostriction displacement sensor 46, but may alternatively be constituted as a displacement sensor of any other type without any problems. The magnetostriction displacement sensor (displacement sensor 46) is configured to cause a current pulse to flow in the bar member 47, and cause the detector 49 to detect a position (travel distance) of the traveling member 48 on the basis of variation in return time of the current pulse depending on a position of a magnet provided to the traveling member 48, i.e., on the basis of time delay about a transmitted pulse and a returned pulse.

The traveling member 48 is a plate member (plate piece), and is fixed to a rear end of the guide member 45. The rim diameter measurement part (not depicted) has a function of the controller 60 configured to control operation of the tire testing machine 1.

As described above, the axes of the air cylinder 41, the guide member 45, and the displacement sensor 46 extend identically in the horizontal direction and are located in an identical plane. The probe 44 and the lower flange 50b of the lower rim 12b are substantially identical in terms of height from a floor surface.

Described next is operation of the rim measurement mechanism 40. When the cylinder rod 42 extends, the probe 44 shifts toward the lower flange 50b of the lower rim 12b. The guide member 45 fixed to the cylinder rod 42 shifts in an identical direction (toward the lower flange 50b) along with the shift of the probe 44.

The traveling member 48 fixed to the rear end of the guide member 45 shifts in an identical direction (toward the lower flange 50b) along with the shift of the guide member 45 along the outer peripheral surface of the bar member 47 in the displacement sensor 46. When the probe 44 comes into contact with the outer circumferential edge 50 (lower flange 50b) of the lower rim 12b, the cylinder rod 42 stops extending.

In the displacement sensor 46, the current pulse flows in the bar member 47 in this case and the detector 49 detects the position (travel amount) of the traveling member 48, on the basis of variation in return time of the current pulse depending on the position of the magnet provided to the traveling member 48. Specifically, the detector 49 detects the travel distance of the traveling member 48 from a predetermined reference point, in other words, a travel distance of the probe 44 from a predetermined reference point. The rim diameter measurement part calculates the diameter at the outer circumferential edge 50 (lower flange 50b) of the lower rim 12b in accordance with the travel distance detected by the detector 49. The rim size of the rim 12 is accordingly obtained.

Described next is a method of managing the rims 12 through measurement of the rim sizes of the rims 12 mounted on the rim table 13.

The rim size management method according to the present embodiment includes a registration step, a measurement step, a determination step, and an avoidance step. The registration step includes registering a rim size of each of the rims 12 mounted on the rim table 13, in association with a corresponding one of the mounting positions. The registration step according to the present embodiment includes registering the diameters of the rims 12 as the rim sizes. The present invention should not be limited to this case, and the registration step may alternatively include registering radii of the rims 12 or other sizes as indices of the sizes of the rims 12.

The measurement step includes actually measuring, with use of the rim measurement mechanism 40, the diameter at the outer circumferential edge of at least one measurement target rim 12 among the plurality of rims 12 mounted on the rim table 13. The determination step includes determining whether or not the diameter thus measured at the outer circumferential edge 50 of the measurement target rim 12 corresponds to a registered rim size as the preliminarily registered rim size in association with the mounting position of the measurement target rim 12 among the plurality of mounting positions. The avoidance step includes executing avoidance operation of avoiding contact between the attachment target rim 12 and the pair of upstream conveyors 11a when the diameter is determined as not corresponding to the registered rim size. The measurement target rim 12 may be identical with or may be different from the attachment target rim 12 among the plurality of rims 12. Alternatively, each of the rims 12 may be the measurement target rim.

The tire testing machine 1 includes a mounting position detector configured to detect which one of the mounting positions on the rim table 13 corresponds to the mounting position of the measurement target rim 12 currently measured in the measurement step. The mounting position detector detects the mounting position and outputs a signal relevant to the mounting position thus detected and received by the controller 60. Examples of the mounting position detector include an absolute encoder, although the present invention is not limited thereto.

For substitution of the rim 12, the operator initially mounts the plurality of rims 12 on the rim table 13, and then preliminarily registers, in the controller 60 configured to control operation of the tire testing machine 1, the information on the plurality of rims 12, the maximum gap between the pair of upstream conveyors 11a, and the like. The information on the plurality of rims 12 includes the rim sizes of the rims 12, widths of the rims 12, sizes of the tires T adapted to the rims 12, and the like.

The pair of upstream conveyors 11a has an appropriate gap obtained in accordance with the rim size of each of the rims 12 with reference to a predetermined calculation formula. This calculation formula is preliminarily stored in the controller 60 configured to control the tire testing machine 1, separately from information on the rim table 13.

Specifically, the controller 60 has a storage region storing, as the predetermined calculation formula, a relation between each of the rim sizes and the appropriate gap between the pair of upstream conveyors 11a. For example, a relation between a rim size D and an appropriate gap X between the pair of upstream conveyors 11a can be provided by a relational expression such as “X=D+10”. The relation between the rim size D and the appropriate gap X between the pair of upstream conveyors 11a can alternatively be provided by relational expressions (1) and (2) as follows.

When 100<D≤150,X=170 (1)

When 150<D≤200,X=220 (2)

Among the plurality of rims 12 mounted on the rim table 13, the attachment target rim 12d as a replacement target (to be attached) passes between the pair of upstream conveyors 11a when ascending from the rim table 13 to above the pair of upstream conveyors 11a along with ascension of the lower spindle 9b supporting the rim 12d. The gap between the pair of upstream conveyors 11a thus needs to be set to the appropriate gap (the gap larger than the outer circumferential diameter of the rim 12d) adapted to the rim size of the rim 12d.

When the lower spindle 9b is located at the standby position after the tire test, the lower spindle 9b is located below the pair of upstream conveyors 11a and the lower rim 12b is not in contact with the rim table 13.

The rim measurement mechanism 40 actually measures the diameter at the outer circumferential edge 50 (lower flange 50b) of the rim to be measured (e.g. the attachment target rim 12d) among the plurality of rims 12 mounted on the rim table 13. The method of measuring the diameter at the lower flange 50b of the rim 12d with use of the rim measurement mechanism 40 is described above.

Subsequently, the diameter thus measured at the outer circumferential edge 50 (lower flange 50b) of the rim 12d (e.g. an attachment rim size as the diameter at the outer circumferential edge 50 of the attachment target rim 12d measured in the measurement step) is compared with the preliminarily registered information on the rim 12d. Specifically, the registered rim size as the preliminarily registered rim size in association with the mounting position of the measurement target rim 12d among the plurality of mounting positions on the rim table 13 is compared with the diameter thus measured of the rim 12d.

The appropriate gap between the pair of upstream conveyors 11a adapted to the rim 12d is calculated in accordance with the preliminarily registered rim size in association with the mounting position of the measurement target rim 12d with reference to the relational expression.

The diameter thus measured of the rim 12 is determined as to whether or not corresponding to the registered rim size. Specifically, the determination step includes determining that the diameter thus measured does not correspond to the registered rim size in a case where the diameter thus measured at the outer circumferential edge 50 of the rim 12d and the registered rim size have a difference equal to or more than a predetermined allowable value. In another case where the difference between the diameter and the registered rim size is less than the allowable range, the diameter thus measured is determined as corresponding to the registered rim size.

When the diameter is determined as not corresponding to the registered rim size, the controller 60 controls operation of the tire testing machine 1 such that the operation for replacement of the rim 12 attached to the spindle unit 9 with the rim 12d thus selected is stopped and the tire test is discontinued. When the diameter is determined as not corresponding to the registered rim size, the controller 60 can alternatively control operation of the tire testing machine 1 to notify the operator of a result of the determination. The determination result may be notified by displaying information on the determination result (e.g. erroneous display) on a display device (not depicted) included in the tire testing machine 1.

When the diameter is determined as not corresponding to the registered rim size, the controller 60 may alternatively be configured to store information on the rim obtained from a value actually measured by the rim measurement mechanism 40, in place of the preliminarily registered information on the rim.

The tire testing machine 1 manages the rim sizes of the rims 12 as described above.

The present embodiment also relates to the following rim size management. The controller 60 selects the rim 12 having the rim size adapted to the size of the tire T as the target of the tire test from among the plurality of rims 12 mounted on the rim table 13 in accordance with the information on the size of the tire T to be tested before conduct of the tire test, and controls operation of the tire testing machine 1 such that the rim 12 thus selected (the attachment target rim) is automatically replaced with the rim 12 attached to the spindle unit 9.

The rim measurement mechanism 40 measures the diameter at the outer circumferential edge 50 of the rim 12 thus selected. If determined in the determination step that the diameter thus measured at the outer circumferential edge 50 does not correspond to the preliminarily registered rim size in association with the mounting position of the rim 12 thus selected, among the plurality of mounting positions, the controller 60 controls operation of the tire testing machine 1 such that, for securement of safety, the operation for replacement of the rim attached to the spindle unit 9 with the rim 12 thus selected is stopped and the tire test is discontinued.

The controller 60 may alternatively control operation of the tire testing machine 1 such that the diameter at the outer circumferential edge 50 (flange 50) of every one of the rims 12 mounted on the rim table 13. Specifically, when a predetermined condition is satisfied, the controller may control operation of the tire testing machine 1 such that the measurement step and the determination step are executed for each of the rims 12. Such operation will be hereinafter called every rim size measurement. In order to achieve the every rim size measurement, when the predetermined condition is satisfied, the controller 60 executes the measurement step of measuring the size at the outer circumferential edge of each of the rims 12 mounted on the rim table 13 individually, and the determination step of determining whether or not the size thus measured at each of the outer circumferential edges corresponds to the registered rim size.

The controller 60 may alternatively control operation of the tire testing machine 1 such that display to urge the operator to execute the every rim size measurement is made when the predetermined condition is satisfied.

Examples of the predetermined condition include a condition (A) that the rim size is registered, a condition (B) that the machine is switched from a power OFF state into a power ON state, and a condition (C) that the tire testing machine 1 is restarted after abnormal stop of the tire testing machine 1.

When at least one of the conditions is satisfied, the controller 60 may control operation of the tire testing machine 1 for automatic execution of the every rim size measurement, or may control operation of the tire testing machine 1 for interlock so as to prevent the tire test from starting unless the operator commands execution of the every rim size measurement.

When the condition (A) is satisfied, in other words, after the rim sizes are registered, the every rim size measurement of the plurality of rims 12 mounted on the rim table 13 is executed in order to check whether or not the information on the registered rims 12 is correct. Specifically, the controller 60 can determine that the condition (A) is satisfied when the raising and lowering mechanism 17 is switched into the raised posture.

Satisfaction of the condition (B) can be exemplified in a case where the operator switches the machine from the power ON state to the power OFF state and thereafter switches into the power ON state. Satisfaction of the condition (B) can also be exemplified in a case where the machine is powered OFF due to power breakdown and the machine is powered ON after recovery from the power breakdown. In either one of these cases, the various sensors in the tire testing machine 1 do not operate and the information in a storage of the controller 60 is not updated in the power OFF state. If any one of the rims 12 on the rim table 13 is replaced and the rim size is not subsequently registered in the power OFF state, the rim sizes of the plurality of rims 12 mounted on the rim table 13 are inconveniently different from the registered rim sizes. The every rim size measurement is accordingly executed if the condition (B) is satisfied.

In a case where the tire testing machine 1 has a power supply system including two sources, namely, a power source and a control source, operation of the tire testing machine 1 may be controlled in the following manner. In such a case, as long as the control source is kept ON even if the power source is switched OFF, the controller 60 can monitor states of the parts constituting the tire testing machine 1. In such a state where the power source is OFF and the control source is ON, if the operator raises the downstream conveyors 11b, the controller 60 can detect such operation and can determine that the rim may have been substituted. When the power source thereafter comes into the ON state or at timing of operation start of the tire testing machine 1 after the power source comes into the ON state, the controller 60 may control operation of the tire testing machine 1 for execution of the every rim size measurement. When the control source is in the OFF state, the controller 60 cannot monitor the states of the parts constituting the tire testing machine 1 and cannot determine whether or not any one of the rims may have been substituted while the control source is in the OFF state. Accordingly, the controller 60 may control operation of the tire testing machine 1 for execution of the every rim size measurement when the control source thereafter comes into the ON state.

When the condition (C) is satisfied, specifically, when the tire testing machine 1 is restarted after abnormal stop of the tire testing machine 1, the controller 60 fails to recognize positions of elements (e.g. a rotary angle of the rim table, the position of a marking device, and the position of the spindle) in the tire testing machine 1. The controller 60 thus controls operation of the tire testing machine 1 such that the elements of the tire testing machine 1 return to origin when the tire testing machine 1 restarts. Simultaneously with or after completion of the return to origin at the elements, the controller 60 controls operation of the tire testing machine 1 for execution of the every rim size measurement.

If the every rim size measurement is executed as described above and the rim automatic replacement is thereafter executed, the rim size of the rim 12 to be replaced is already measured constantly, without need for measurement of the rim size of the rim 12 upon rim replacement. This achieves reduction in cycle time of the tire test, as well as avoidance of inconvenient discontinuation of the tire test due to the diameter not corresponding to the registered rim size.

The controller 60 stores the diameter of the rim 12d actually measured with use of the rim measurement mechanism 40 in association with the mounting position of the rim 12d.

In a case where the plurality of rims 12 mounted on the rim table 13 is successively measured in terms of the diameters, after measurement of the diameter at the outer circumferential edge 50 of one of the rims 12, the controller 60 controls operation of the tire testing machine 1 to rotate the rim table 13 in order to shift the subsequent measurement target rim 12 to a measurement position for measurement of the diameter at the outer circumferential edge 50 (flange 50) of the subsequent rim 12. Such a measurement cycle is repeated to measure the diameter at the outer circumferential edge of every one of the rims 12 mounted at all the mounting positions (all positions) on the rim table 13. The controller 60 stores results of such measurement, that is, the rim size of the rim mounted at each of the mounting positions (each position) in association with the information on a corresponding one of the mounting positions.

In the every rim size measurement, the controller 60 may control operation of the tire testing machine 1 such that the measurement step and the determination step are discontinued when the size at the outer circumferential edge of one of the rims 12 mounted at the plurality of mounting positions on the rim table 13 is determined as not corresponding to the registered rim size in the determination step, even if the measurement step and the determination step are not completed for every one of the rims 12. Such a configuration will be described specifically.

The rim table 13 according to the present embodiment has the four mounting positions provided with four rims 12 specifically including the rim 12 mounted at a mounting position A, the rim 12 mounted at a mounting position B, the rim 12 mounted at a mounting position C, and the rim 12 mounted at a mounting position D. In such a case, for execution of the every rim size measurement, the measurement step includes a first measurement step, a second measurement step, a third measurement step, and a fourth measurement step. The first to fourth measurement steps include measuring the sizes at the outer circumferential edges of the four rims 12. For execution of the every rim size measurement, the determination step includes a first determination step, a second determination step, a third determination step, and a fourth determination step. The first determination step includes determining whether or not the size at the outer circumferential edge of the rim 12 measured in the first measurement step (the rim 12 mounted at the mounting position A) corresponds to the registered rim size in association with the mounting position A of the rim 12. The second to fourth determination steps are executed in similar manners.

The measurement step and the determination step described above are executed in the exemplarily mentioned order of the first measurement step, the first determination step, the second measurement step, the second determination step, the third measurement step, the third determination step, the fourth measurement step, and the fourth determination step. That is, the plurality of measurement steps has a preset execution order, whereas the plurality of determination steps has a preset execution order. For example, the controller 60 controls operation of the tire testing machine 1 such that the measurement step and the determination step are discontinued when the size at the outer circumferential edge of the rim 12 mounted at the mounting position C in the third measurement step is determined as not corresponding to the registered rim size in the third determination step, even if the fourth measurement step and the fourth determination step are not completed.

The sizes of the rims 12 are measured preferably during appropriate time while no tire test is conducted, such as upon mounting the rims 12 on the rim table 13 (upon rim mounting) or upon substituting part or all of the rims 12 mounted on the rim table 13 by the externally prepared rims different in size.

If the predetermined condition is satisfied or if the controller 60 detects some operation to any of the rims 12 after measurement of the diameter of the rim 12, every one of the rims 12 mounted on the rim table 13 may be subjected to measurement of the diameter.

In a case where, after measurement of the diameter of the rim 12, at least part of the rims 12 mounted on the rim table 13 is substituted and the rim size is not subsequently registered, the information on the registered rims 12 may be different from the rim sizes of the rims 12 actually mounted on the rim table 13. If the substituted rim 12 is larger in rim size than the previous rim 12, the gap between the pair of upstream conveyors 11a does not correspond to the appropriate gap adapted to the substituted rim 12. When the rim 12 is replaced in such a state, the rim 12 may come into contact with the pair of upstream conveyors 11a. In order to avoid such contact, the tire testing machine 1 may be controlled to certainly execute automatic measurement of the rim size of every one of the rims 12 mounted at all the positions on the rim table 13 immediately before the tire test starts after starting up the tire testing machine 1.

The basal ends of the pair of the downstream conveyors 11b may be provided with sensors or the like, and the tire testing machine 1 may be controlled to have a raised state of the pair of downstream conveyors 11b monitored by the sensors. Specifically, when the pair of downstream conveyors 11b is switched into the raised state, any of the rims 12 may have been substituted after measurement of the rim size of the rim 12. In such a case where the pair of downstream conveyors 11b is switched into the raised state, operation of the tire testing machine 1 may be controlled to certainly execute automatic measurement of the diameter of every one of the rims 12 mounted at all the mounting position (all the positions) on the rim table 13 before the tire test starts.

In order to prevent erroneous substitution of at least one of the rims 12 mounted on the rim table 13 after measurement of the rim size, there may be provided a restrictor configured to restrict entry of the operator to a rim replacement position (substitution position).

The tire testing machine 1 may be further provided with a lock unit (interlock) configured to prevent some operation to the rims 12 upon detection of the operation after measurement of the size of the rim 12. The tire testing machine may be configured to detect, in a case where the lock unit is being released, such release and operate the interlock (safety mechanism).

As described above, the present embodiment achieves correct rim size management through actual measurement, with use of the rim measurement mechanism 40, of the diameter of at least one measurement target rim 12 among the plurality of rims 12 mounted on the rim table 13, and comparison between the information on the rim 12 obtained from the measurement result and preliminarily registered data on the rims sizes of the rims 12.

The embodiment disclosed herein should be regarded as being exemplary and nonlimitive at any point.

Particularly, the embodiment disclosed herein includes matters not disclosed explicitly, such as running conditions, operation conditions, various parameters, as well as dimensions, weight, volume, and the like of constituent elements. These matters have values set so as not to depart from an ordinarily implemented range by those skilled in the art and so as to be easily assumed by those skilled in the art.

The rim measurement mechanism 40 according to the present embodiment includes the air cylinder adopted as the expansion mechanism 41, the roller adopted as the probe 44, and the displacement sensor adopted as the measurement section 46. This configuration is merely exemplary, and the present invention should not be limited to this exemplification.

The present embodiment exemplifies the case of measuring the diameter at the lower flange 50b of the lower rim 12b. The tire testing machine may alternatively be configured to measure both a flange 50a and the flange 50b of the upper rim 12a and the lower rim 12b, or measure only the diameter at the upper flange 50a of the upper rim 12a.

The measurement step according to the above embodiment includes measuring the diameter as the size at the outer circumferential edge 50 of the rim. The present invention should not be limited to this case, and the size at the outer circumferential edge 50 may alternatively be the radius or any other size as an index of the rim size.

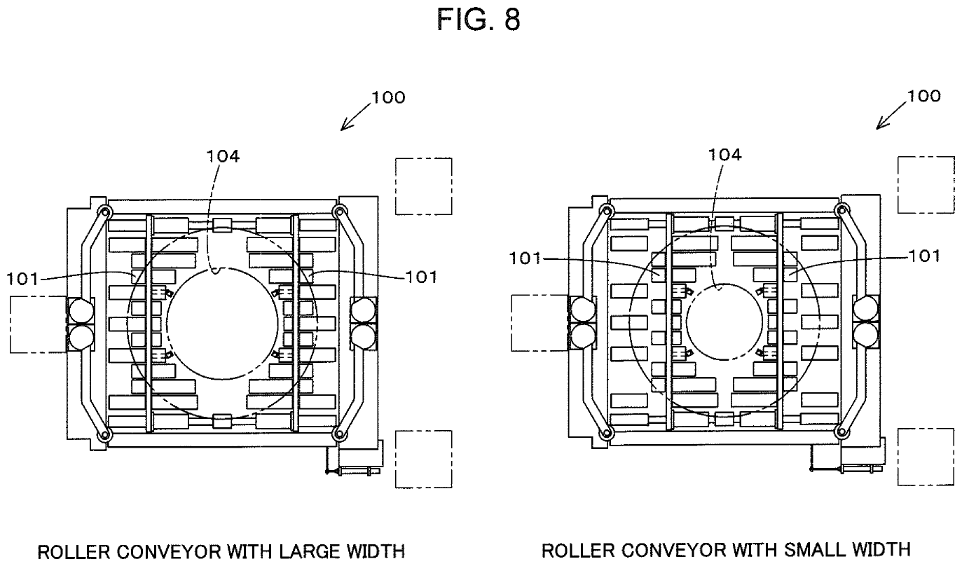

The above embodiment provides, as the pair of conveyors relevant to the rim size management method according to the present invention, the pair of upstream conveyors 11a constituted as the pair of belt conveyors. The present invention should not be limited to this case. The pair of conveyors relevant to the rim size management method according to the present invention may alternatively be constituted as a pair of roller conveyors or the like. The pair of roller conveyors may be constituted as roller conveyors exemplarily depicted in FIG. 8. As depicted in FIG. 8, the paired roller conveyors each include a plurality of rollers aligned in the conveyance direction of the tire. The pair of roller conveyors has an adjustable gap therebetween as depicted in FIG. 8.

The specific embodiment described above primarily includes aspects of the invention relevant to the following configurations.

The present invention provides a rim size management method of managing rim sizes of a plurality of rims in a tire testing machine including a pair of conveyors configured to convey a tire as a target of a tire test, a rim table disposed below the pair of conveyors and having a plurality of mounting positions to be provided with the plurality of rims including a first rim and a second rim and varied in rim size, a spindle unit to be provided with a rim, and a rim measurement mechanism, the tire testing machine configured to shift an attachment target rim mounted at one of the mounting positions from the rim table to above the pair of conveyors by allowing the attachment target rim to pass between the pair of conveyors in a state where the pair of conveyors has an appropriate gap adjusted to be adapted to a rim size of the attachment target rim when the attachment target rim is attached to the spindle unit. The rim size management method for the tire testing machine includes: a registration step of registering a rim size of each of the rims mounted on the rim table in association with a corresponding one of the mounting positions; a measurement step of actually measuring, with use of the rim measurement mechanism, a size at an outer circumferential edge of at least the first rim mounted at a first mounting position among the plurality of mounting positions; a determination step of determining whether or not the size thus measured at the outer circumferential edge of the first rim corresponds to a registered rim size as the rim size preliminarily registered in association with the first mounting position; and an avoidance step of executing avoidance operation of avoiding contact between the attachment target rim and the pair of conveyors when the size at the outer circumferential edge of the first rim is determined as not corresponding to the registered rim size.

Upon rim replacement of attaching the attachment target rim to the spindle unit in the tire testing machine, the gap between the pair of conveyors is appropriately adjusted to the rim size of the attachment target rim, and the attachment target rim shifts from the rim table to above the pair of conveyors through the gap between the pair of conveyors. The rim size management method for the tire testing machine thus configured achieves avoidance of contact between the attachment target rim and the pair of conveyors when the attachment target rim passes between the pair of conveyors upon the rim replacement, even if registered information on the plurality of rims is incorrectly registered preliminarily in the registration step. The rim size management method according to the present invention includes measuring the size at the outer circumferential edge of the first rim in the measurement step, determining whether or not the size thus measured corresponds to the registered rim size in the determination step, and executing the avoidance operation of avoiding contact between the attachment target rim and the pair of conveyors in the avoidance step when the size thus measured at the outer circumferential edge is determined as not corresponding to the registered rim size. Examples of the avoidance operation include operation to discontinue the rim replacement, operation to discontinue the tire test, and operation to notify the operator of rim related information on incorrectly registered information, possibility of contact between the rim and the conveyors, or the like, when the size at the outer circumferential edge is determined as not corresponding to the registered rim size.

In the present invention, the first rim to be measured may be identical to or different from the attachment target rim to be attached to the spindle unit upon the rim replacement. Even in the case where the first rim to be measured is different from the attachment target rim, when the size at the outer circumferential edge of the first rim is determined as not corresponding to the registered rim size, the registered information on the rims other than the first rim may be incorrect. When the avoidance operation is executed in such a case, the attachment target rim is likely to avoid contacting the pair of conveyors.

In the rim size management method, optionally, the plurality of mounting positions includes at least the first mounting position and a second mounting position, the first rim is mounted at the first mounting position, and the second rim is mounted at the second mounting position, the measurement step includes actually measuring, with use of the rim measurement mechanism, a size at an outer circumferential edge of the second rim, the attachment target rim is either the first rim or the second rim, the determination step includes determining whether or not an attachment rim size as the size at the outer circumferential edge of the attachment target rim measured in the measurement step corresponds to a registered rim size preliminarily registered in association with the mounting position of the attachment target rim, and the avoidance step includes executing the avoidance operation when the attachment rim size is determined as not corresponding to the registered rim size.

According to this aspect, the attachment target rim attached to the spindle unit is either the first rim or the second rim, is the rim having the size (attachment rim size) measured in the measurement step, and is the rim determined in the determination step whether or not the attachment rim size corresponds to the registered rim size. In the avoidance step according to this aspect, the avoidance operation is executed when the attachment rim size is determined as not corresponding to the registered rim size. Even if the information on the attachment target rim is preliminarily registered incorrectly in the registration step, at least the attachment target rim is determined in the determination step to avoid contact between the attachment target rim passing between the pair of conveyors and the pair of conveyors upon the rim replacement.

Preferably, in the rim size management method, the determination step includes determining that the size at the outer circumferential edge thus measured in the measurement step does not correspond to the registered rim size when the size thus measured at the outer circumferential edge and the registered rim size have a difference equal to or more than a predetermined allowable value.

According to this aspect, there is predetermined the allowable value for determination of whether or not the size thus measured at the outer circumferential edge corresponds to the registered rim size. Even if there is any error upon measurement of the size at the outer circumferential edge, the size thus measured at the outer circumferential edge is determined as corresponding to the registered rim size when the error is included within a range of the allowable value. This inhibits excessive execution of the avoidance operation by the tire testing machine. This avoids contact between the attachment target rim and the pair of conveyors as well as achieves smooth conduct of the tire test.

Preferably, in the rim size management method, the rim measurement mechanism includes an expansion mechanism disposed to expand toward the outer circumferential edge of the rim having the size at the outer circumferential edge to be measured by the rim measurement mechanism, a measurement section having a bar member disposed parallel to an expansion direction in which the expansion mechanism expands and a traveling member shifting along the bar member, and a guide member disposed parallel to the expansion direction and linking the expansion mechanism and the traveling member in the measurement section, and the measurement step includes calculating a travel distance, from a predetermined reference point, of the traveling member linked with the expansion mechanism via the guide member when the expansion mechanism expands to have a tip coming into contact with the outer circumferential edge, and calculating the size at the outer circumferential edge in accordance with the travel distance.

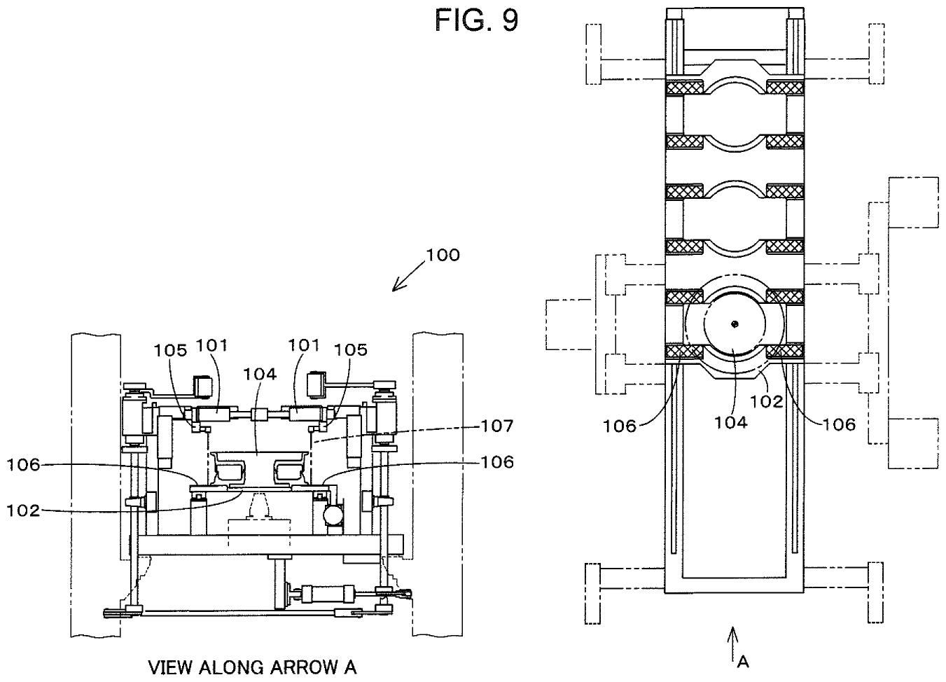

The rim measurement mechanism according to this aspect is configured as a contact measurement mechanism. This configuration avoids inconvenience possibly caused by an optical measurement mechanism or the like, to achieve stable measurement of the rim size. Specifically, as exemplarily depicted in FIG. 9, the optical measurement mechanism includes a sensor 105 configured to apply light, and a reflective plate 106 configured reflect the light applied from the sensor 105. The size of the rim 104 is compared with the gap between the conveyor units 101 in accordance with whether or not the rim 104 blocks the light applied from the sensor 105 (an applied light line 107). The reflective plate 106 in the optical measurement mechanism may fail to appropriately reflect the light applied from the sensor 105 due to adhesion of dust or the like. The reflective plate 106 is, for example, pasted to an upper surface of a rim table 102. When the rim repetitively comes into contact with the reflective plate 106 through a large number of times of rim replacement, the reflective plate 106 may be peeled off from the upper surface of the rim table 102. As a measure to prevent such peeling of the reflective plate 106, there may be adopted a processing method of embedding the reflective plate 106 made of resin in the upper surface of the rim table 102. Such a processing method of embedding the reflective plate in the upper surface of the rim table needs much time and effort as well as high cost, and is not regarded as an appropriate measure. The present aspect provided with the rim measurement mechanism constituted as the contact measurement mechanism does not need the reflective plate included in the optical measurement mechanism and thus does not cause the inconvenience due to the adhesion of dust or peeling of the reflective plate.

Preferably, in the rim size management method, the tire testing machine further includes a controller configured to control operation of the tire testing machine, and the controller controls operation of the tire testing machine such that, when a predetermined condition is satisfied, the size at the outer circumferential edge is individually measured for each of the rims mounted on the rim table in the measurement step, and whether or not the size thus measured at the outer circumferential edge corresponds to the registered rim size is determined in the determination step.

According to this aspect, satisfaction of the predetermined condition is followed by every rim size measurement including the measurement step and the determination step for each of the rims mounted on the rim table. Execution of the rim replacement after the every rim size measurement does not need operation for the measurement step and the determination step. This is because, after completion of the every rim size measurement, measurement in the measurement step and determination in the determination step are already completed for each of the rims mounted on the rim table. This achieves reduction in cycle time of the tire test. This also reduces frequency of the avoidance operation upon conduct of the tire test, and reduces frequency of discontinuation of the tire test.

Optionally, in the rim size management method, the controller controls operation of the tire testing machine such that the measurement step and the determination step are discontinued when the size at the outer circumferential edge of one of the rims is determined as not corresponding to the registered rim size in the determination step, even if the measurement step and the determination step are not completed for every one of the rims.

According to this aspect, even if the every rim size measurement has started and has not been completed, the every rim size measurement is stopped when the size at the outer circumferential edge of any of the rims is determined as not corresponding to the registered rim size. This enables execution of the avoidance operation upon the determination, specifically, e.g., operation to notify the operator of rim related information on incorrectly registered information, possibility of contact between the rim and the conveyors, or the like.

Optionally, in the rim size management method, the controller updates the registered rim size for at least one of the rims in accordance with a result of determination in the determination step.

When the size at the outer circumferential edge of any of the rims is determined as not corresponding to the registered rim size, this aspect enables automatic update of the registered rim size according to a result of the determination.

Preferably, in the rim size management method, the tire testing machine further includes a controller configured to control operation of the tire testing machine, and the controller controls operation of the tire testing machine such that the tire test is discontinued when the size at the outer circumferential edge thus measured in the measurement step is determined as not corresponding to the registered rim size in the determination step.

According to this aspect, the avoidance operation includes controlling operation of the tire testing machine to discontinue the tire test. This achieves reliable avoidance of contact between the pair of conveyors and the rim.

Preferably, in the rim size management method, the tire testing machine further includes a controller configured to control operation of the tire testing machine, the controller is configured to select the attachment target rim as the rim having the rim size adapted to the size of the tire as the target of the tire test from among the plurality of rims mounted on the rim table in accordance with information on the size of the tire to be tested before conduct of the tire test, and control operation of the tire testing machine such that the attachment target rim thus selected is automatically replaced with the rim attached to the spindle unit, and when the size at the outer circumferential edge of the attachment target rim thus selected is measured in the measurement step and the size thus measured at the outer circumferential edge is determined as not corresponding to the rim size preliminarily registered in association with one of the mounting positions corresponding to the attachment target rim thus selected in the determination step, the controller controls operation of the tire testing machine such that the operation for replacement of the rim attached to the spindle unit with the attachment target rim thus selected is stopped and the tire test is discontinued.

According to this aspect, when the attachment target rim thus selected is not adapted to the preliminarily registered rim size in a process of automatically replacing the rim attached to the spindle unit with the rim adapted to the size of the tire as the target of the tire test, the rim replacement is stopped and the tire test is discontinued. This achieves reliable avoidance of contact between the pair of conveyors and the rim.

1. A rim size management method of managing rim sizes of a plurality of rims in a tire testing machine including a pair of conveyors configured to convey a tire as a target of a tire test, a rim table disposed below the pair of conveyors and having a plurality of mounting positions to be provided with the plurality of rims including a first rim and a second rim and varied in rim size, a spindle unit to be provided with a rim, and a rim measurement mechanism, the tire testing machine configured to shift an attachment target rim mounted at one of the mounting positions from the rim table to above the pair of conveyors by allowing the attachment target rim to pass between the pair of conveyors in a state where the pair of conveyors has an appropriate gap adjusted to be adapted to a rim size of the attachment target rim when the attachment target rim is attached to the spindle unit, the method comprising:
a registration step of registering a rim size of each of the rims mounted on the rim table in association with a corresponding one of the mounting positions;
a measurement step of actually measuring, with use of the rim measurement mechanism, a size at an outer circumferential edge of at least the first rim mounted at a first mounting position among the plurality of mounting positions;
a determination step of determining whether or not the size thus measured at the outer circumferential edge of the first rim corresponds to a registered rim size as the rim size preliminarily registered in association with the first mounting position; and
an avoidance step of executing avoidance operation of avoiding contact between the attachment target rim and the pair of conveyors when the size at the outer circumferential edge of the first rim is determined as not corresponding to the registered rim size.

2. The rim size management method in the tire testing machine according to claim 1, wherein
the plurality of mounting positions includes at least the first mounting position and a second mounting position,
the first rim is mounted at the first mounting position, and the second rim is mounted at the second mounting position,
the measurement step includes actually measuring, with use of the rim measurement mechanism, a size at an outer circumferential edge of the second rim,
the attachment target rim is either the first rim or the second rim,
the determination step includes determining whether or not an attachment rim size as the size at the outer circumferential edge of the attachment target rim measured in the measurement step corresponds to a registered rim size preliminarily registered in association with the mounting position of the attachment target rim, and
the avoidance step includes executing the avoidance operation when the attachment rim size is determined as not corresponding to the registered rim size.

3. The rim size management method in the tire testing machine according to claim 1, wherein
the determination step includes determining that the size at the outer circumferential edge thus measured in the measurement step does not correspond to the registered rim size when the size thus measured at the outer circumferential edge and the registered rim size have a difference equal to or more than a predetermined allowable value.

4. The rim size management method in the tire testing machine according to claim 1, wherein
the rim measurement mechanism includes an expansion mechanism disposed to expand toward the outer circumferential edge of the rim having the size at the outer circumferential edge to be measured by the rim measurement mechanism, a measurement section having a bar member disposed parallel to an expansion direction in which the expansion mechanism expands and a traveling member shifting along the bar member, and a guide member disposed parallel to the expansion direction and linking the expansion mechanism and the traveling member in the measurement section, and
the measurement step includes calculating a travel distance, from a predetermined reference point, of the traveling member linked with the expansion mechanism via the guide member when the expansion mechanism expands to have a tip coming into contact with the outer circumferential edge, and calculating the size at the outer circumferential edge in accordance with the travel distance.

5. The rim size management method in the tire testing machine according to claim 1, wherein
the tire testing machine further includes a controller configured to control operation of the tire testing machine, and
the controller controls operation of the tire testing machine such that, when a predetermined condition is satisfied, the size at the outer circumferential edge is individually measured for each of the rims mounted on the rim table in the measurement step, and whether or not the size thus measured at the outer circumferential edge corresponds to the registered rim size is determined in the determination step.

6. The rim size management method in the tire testing machine according to claim 5, wherein
the controller controls operation of the tire testing machine such that the measurement step and the determination step are discontinued when the size at the outer circumferential edge of one of the rims is determined as not corresponding to the registered rim size in the determination step, even if the measurement step and the determination step are not completed for every one of the rims.

7. The rim size management method in the tire testing machine according to claim 5, wherein
the controller updates the registered rim size for at least one of the rims in accordance with a result of determination in the determination step.

8. The rim size management method in the tire testing machine according to claim 1, wherein
the tire testing machine further includes a controller configured to control operation of the tire testing machine, and
the controller controls operation of the tire testing machine such that the tire test is discontinued when the size at the outer circumferential edge thus measured in the measurement step is determined as not corresponding to the registered rim size in the determination step.

9. The rim size management method in the tire testing machine according to claim 1, wherein
the tire testing machine further includes a controller configured to control operation of the tire testing machine,
the controller is configured to select the attachment target rim as the rim having the rim size adapted to the size of the tire as the target of the tire test from among the plurality of rims mounted on the rim table in accordance with information on the size of the tire to be tested before conduct of the tire test, and control operation of the tire testing machine such that the attachment target rim thus selected is automatically replaced with the rim attached to the spindle unit, and
when the size at the outer circumferential edge of the attachment target rim thus selected is measured in the measurement step and the size thus measured at the outer circumferential edge is determined as not corresponding to the rim size preliminarily registered in association with one of the mounting positions corresponding to the attachment target rim thus selected in the determination step, the controller controls operation of the tire testing machine such that the operation for replacement of the rim attached to the spindle unit with the attachment target rim thus selected is stopped and the tire test is discontinued.
